(19) United States
(12) Patent Application Publication
(10) Pub. No.: US 2022/0307480 A1
(43) Pub. Date: Sep. 29, 2022

(54) THREE-PROPELLER COUNTER-ROTATING WIND TURBINE

(71) Applicant: MEGABIZ PETROKIMYA ÜRÜNLERI SANAYI VE TICARET ANONIM SIRKETI, BAHCELIEVLER/ ISTANBUL (TR)

(72) Inventor: Erdem Ì Can, BAHCELIEVLER/ ISTANBUL (TR)

(73) Assignee: MEGABIZ PETROKIMYA ÜRÜNLERI SANAYI VE TICARET ANONIM SIRKETI, BAHCELIEVLER/ ISTANBUL (TR)

(21) Appl. No.: 17/433,597

(22) PCT Filed: Sep. 7, 2020
(86) PCT No.: PCT/TR2020/050815

§ 371 Date: Aug. 24, 2021

(30) Foreign Application Priority Data
Jul. 24, 2020 (TR) 2020/11794

(51) Int. Cl. F03D 15/20; F03D 1/06; H02K 7/18

(52) U.S. Cl. CPC F03D 15/20; F03D 1/065; H02K 7/1838; F05B 2240/221; F05B 2220/706

(57) ABSTRACT

The invention relates to a three-propeller counter-rotating wind turbine that needs a smaller installation area compared to conventional wind turbines that are currently in use for the generation of electrical energy by benefitting from wind power in windy environments, and that nevertheless has higher production capacity, as well as increased productivity, and that does not employ gears, and that has a direct drive mechanism.

### TECHNICAL FIELD

The invention relates to a three-propeller counter-rotating wind turbine that needs a smaller installation area compared to conventional wind turbines that are currently in use for the generation of electrical energy by benefitting from wind power in windy environments, and that nevertheless has higher production capacity, as well as increased productivity, and that does not employ gears, and that has a direct drive mechanism.

### BACKGROUND ART

Energy is described as the ability to do work. Currently, the need for energy is rapidly increasing as a result of ever-growing economies and industrial activities. Industrial activities result in the use of electrical energy as the main source of energy. Fossil-sourced fuels (gasoline, coal, natural gas, etc.) are heavily utilized in the production of energy.

Old energy production technologies are slowly being abandoned since reserves of fossil-sourced fuels are rapidly being exhausted and the use of such materials damages the environment. Carbon dioxide, sulfur dioxide, nitrous oxide, dust, and soot emitted into the earth's atmosphere as a result of the utilization of fossil fuels lead to great adverse effects on the immediate environment while carbon dioxide and similar greenhouse gases cause global climate change and pose a threat to the whole world. In the face of all these negativities, researches and studies on clean and renewable energy sources have been started and applications have been initiated to utilize these resources in various areas. Solar and wind energies are the two leading clean and renewable energy sources. Solar energy is the cleanest and free source of energy that is used in the present day. With an ever-growing use, solar energy is now being employed to produce electrical energy as well, thanks to the recent advances in technology, although it was previously only used for heat energy. The rate of use of solar energy depends on the weather and number of sunny days within a year. Cloudy and overcast weather restricts the ability to benefit from solar energy. This situation reduces the productivity of solar panels that are installed to obtain electrical energy from solar energy.

Following solar energy, wind energy is the most used source of clean and renewable energy. Wind turbines installed to benefit from wind energy rotate with the airflow created by the wind, and electrical energy can be obtained thanks to the magnetic field created as a result of this rotational motion. Currently used wind turbines occupy very large areas for their installation, but are not sufficiently efficient in the generation of electrical energy considering the installation area.

One of the reasons behind low production efficiency in traditional wind turbines is the conventional single-propeller structure. Only one propeller is used to benefit from wind power in the area where the relevant wind turbine is set up, and this leads to the inability to take advantage of the potential wind power to the fullest extent possible. Another reason behind low production efficiency, on the other hand, is the gear structures used in transferring the rotational motion as a result of wind power to the generator which will produce electrical energy. Motion energy transferred to the generator is a bit lost due to the gears used in turbines, and this translates into the production of electrical energy as a decrease in productivity.

There have been several works focusing on wind turbines that are utilized for the production of electrical energy by making use of wind power, and a national patent application numbered TR 2020/05258 describes a “Vertical axis wind turbine with increased efficiency”. It is explained that the concerned invention is a vertical axis wind turbine with a weight-compensated tail system, whose eccentricity diameter can vary according to the blade width, and it is stated that the wind turbine consists of a certain number of blades, an alternator system, an eccentric motion mechanism that provides the transfer of motion between blades and a rotor or the alternator system, arms for each blade connecting the blade to the eccentric motion mechanism, and a tail.

National utility model application numbered TR 2020/01184 introduces a “High-efficiency horizontal axis wind turbine with wide and short blades”. It is explained that the capacity of residential wind turbines is not sufficient, and that the relevant invention is designed to generate higher electrical energy from the wind with lower cost without requiring a second mast and other materials in order to meet all energy needs of residences. It is indicated that turbines are of horizontal axis type, and that the blades are wide and short, and that the designed blade surface presents an increased ability to benefit from wind.

European Patent application with publication number EP3341608B1 describes a “Tunnel wind turbine with a horizontal axis of the rotor rotation”. It is stated that the turbine subject to the invention contains a diffuser in the form of a rotational body, the wall of which has the shape of a convex-concave aeronautical profile in the axial section and a rotor with blades rotating in the plane of a throat of the diffuser and connected with a hub by lower ends.

Another European Patent application with publication number EP3121441B1 depicts a “Rotor blade root assembly for a wind turbine”. It is explained that the said invention relates to a root assembly for a rotor blade of a wind turbine and methods of manufacturing the same. It is expressed that the root assembly includes a blade root section having an inner sidewall surface and an outer sidewall surface separated by a radial gap, a plurality of root inserts spaced circumferentially within the radial gap, and a plurality of spacers configured between one or more of the root inserts. In conclusion, the need to eliminate the above-mentioned shortcomings and disadvantages of the current technique has necessitated a development in the relevant technical field.

### AIM OF THE INVENTION

The present invention relates to a three-propeller counter-rotating wind turbine that is developed to remove the above-mentioned disadvantages and provide new advantages to the relevant technical field.

The aim of the invention is to create a wind turbine structure that contains more propellers and blades in comparison to the conventional propeller structure employed in wind turbines currently in use, and that also utilizes a direct drive mechanism in transferring the rotational motion obtained from wind power to the generator.

Another aim of the invention is to form a structure that allows benefitting from potential wind power per unit area at an increased level and thereby enables a higher efficiency in the production of electrical energy, thanks to the creation of a wind turbine structure that contains more propellers and blades in comparison to the conventional propeller structure employed in wind turbines currently in use, and that also utilizes a direct drive mechanism in transferring the rotational motion obtained from wind power to the generator.

Another aim of the invention is to ensure the minimization of costs incurred in the generation of electrical energy, thanks to the formation of a structure that allows benefitting from potential wind power per unit area at an increased level and thereby enables a higher efficiency in the production of electrical energy.

Structural and characteristic features of the invention, as well as all of its advantages, will be understood more clearly with the figures given below and the detailed description written by referring to the relevant figures, and therefore, the evaluation should be made by taking into consideration of the said figures and detailed description.

### SHORT EXPLANATION OF THE FIGURES

The applications of the present invention that is briefly summarized above and addressed in detail below can be understood by referring to the sample applications depicted in the attached drawings of the invention. However, it must be stated that the attached drawings show only the typical applications of this invention and that since the invention allows other equally effective applications, its scope cannot be assumed to be limited.

In order to facilitate understanding, identical reference numbers are used to indicate identical elements in the figures, where possible. The shapes are not drawn to scale and can be simplified for clarity. It is believed that the elements and features of an application can be usefully incorporated into other applications without further explanation.

FIG. 1: It is a representative perspective view of the product subject to the invention from the front.

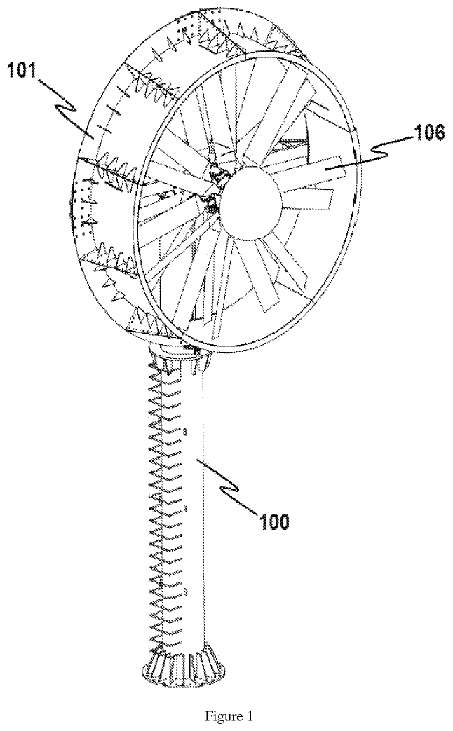

FIG. 2: It is a representative perspective view of the product subject to the invention from the back.

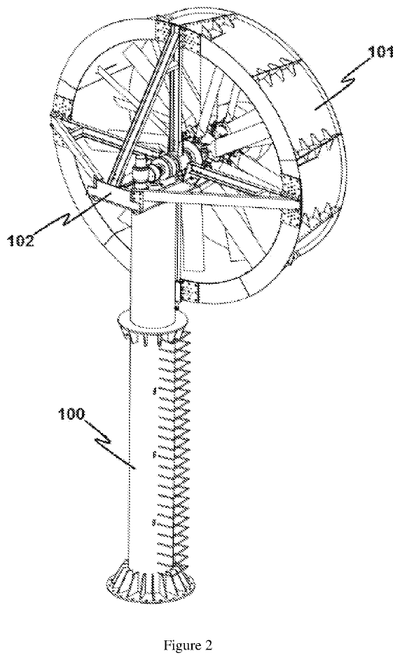

FIG. 3: It is a representative perspective view of the details of the mechanism of the product subject to the invention.

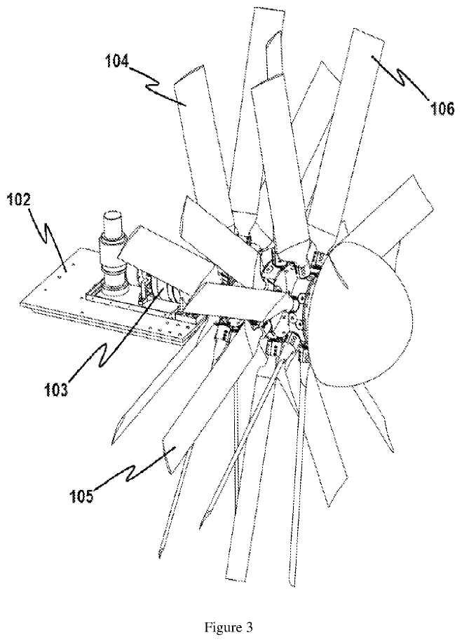

FIG. 4: It is a representative view of the details of the mechanism of the product subject to the invention from the side.

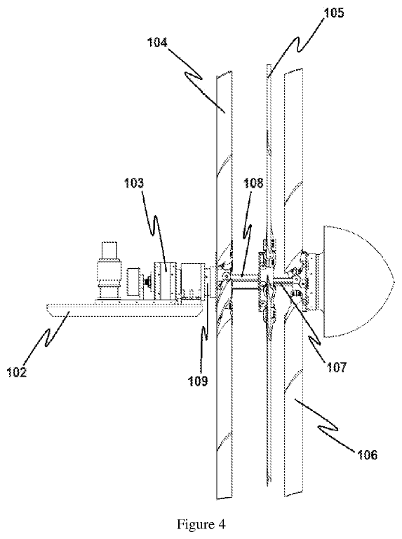

### REFERENCE NUMBERS

100. Tower
101. Propeller housing
102. Nacelle
103. Counter-rotating generator
104. Rear blade group
105. Central blade group
106. Front blade group
107. First rotor
108. Second rotor
109. Third rotor

### DETAILED EXPLANATION OF THE INVENTION

Alternatives selected for this detailed description of the product subject to the invention are described only to ensure a better understanding of the subject and in a way that will not create any limiting impact.

The invention relates to a three-propeller counter-rotating wind turbine that is used to obtain electrical energy by benefitting from wind power in windy and high wind potential environments, and that needs a smaller installation area compared to conventional wind turbines that are currently in use, and that nevertheless has higher production capacity, as well as increased productivity, and that does not employ gears, and that has a direct drive mechanism.

The product subject to the invention, in general, includes minimum one rear blade group (104) composed of minimum five blades, minimum one front blade group (106) composed of minimum seven blades, minimum one central blade group (105) placed between rear blade group (104) and front blade group (106) and composed of minimum nine blades, minimum one third rotor (109) that is linked to the rear blade group (104) and turns counter-clockwise, minimum one second rotor (108) that is linked to the central blade group (105), turns clockwise, and passes through the third rotor (109), minimum one first rotor (107) that is linked to the front blade group (106), turns counter-clockwise, and passes through the third rotor (109) and the second rotor (108), minimum one counter-rotating generator (103) whose stator is revolved by the first rotor (107) and the third rotor (109) and whose rotor is rotated in the opposite direction by the second rotor (108), minimum one propeller housing (101) in which the front blade group (106), the rear blade group (104), and the central blade group (105) are contained and rotate, minimum one nacelle (102) that contains the whole mechanism on its body, and minimum one tower (100) that carries and lifts the whole structure.

Blades found in the front blade group (106), the rear blade group (104), and the central blade group (105) have preferably an angle of 60 degrees.

The first rotor (107) and the third rotor (109) connected to the front blade group (106) and the rear blade group (104) rotating with the effect of the wind directly turn the stator of the counter-rotating generator (103) while the second rotor (108) connected to the central blade group (105) rotating in the opposite direction of the front blade group (106) and the rear blade group (104) turns the rotor of the counter-rotating generator (103). No gear system is used in transmitting the rotational motion achieved from the wind to the counter-rotating generator (103), so the counter-rotating generator (103) whose rotor and stator are driven directly in opposite directions can efficiently generate electrical energy. Wind power can be utilized effectively thanks to a large number of blades in the front blade group (106), the central blade group (105), and the rear blade group (104). Based on these facts, the amount of electrical energy obtained per unit installation area can be kept at higher levels compared to conventional wind turbines, and electrical energy production costs can be reduced.

The number and angles of blades in the turbine can be altered to adjust turbine performance at an appropriate and desired level according to meteorological data relating to each installation area.

The product subject to the invention may be installed with or without the propeller housing (101).

In an alternative structuring of the invention, the first rotor (107), the second rotor (108), and the third rotor (109) are disconnected in order to reduce energy losses at the highest level, and the front blade group (106), the central blade group (105) and the rear blade group (104) are directly connected to the body of the counter-rotating generator (103).

1. The invention relates to a three-propeller counter-rotating wind turbine that is used to obtain electrical energy by benefitting from wind power in windy and high wind potential environments, and that needs a smaller installation area compared to conventional wind turbines that are currently in use, and that nevertheless has higher production capacity, as well as increased productivity, and that does not employ any gear system, and that has a direct drive mechanism, and its feature is that it includes
minimum one rear blade group (104) composed of minimum five blades,
minimum one front blade group (106) composed of minimum seven blades,
minimum one central blade group (105) placed between the rear blade group (104) and the front blade group (106) and composed of minimum nine blades,
minimum one third rotor (109) that is linked to the rear blade group (104) and turns counter-clockwise,
minimum one second rotor (108) that is linked to the central blade group (105), turns clockwise, and passes through the third rotor (109),
minimum one first rotor (107) that is linked to the front blade group (106), turns counter-clockwise, and passes through the third rotor (109) and the second rotor (108),
minimum one counter-rotating generator (103) whose stator is rotated by the first rotor (107) and the third rotor (109) and whose rotor is rotated in the opposite direction by the second rotor (108).

2. Being a three-propeller counter-rotating wind turbine in accordance with claim 1, its feature is that it is comprised of minimum one propeller housing (101) in which the front blade group (106), the rear blade group (104), and the central blade group (105) are contained and rotate.

3. Being a three-propeller counter-rotating wind turbine in accordance with claim 1, its feature is that it includes minimum one nacelle (102) that contains the whole mechanism on its body.

4. Being a three-propeller counter-rotating wind turbine in accordance with claim 1, its feature is that it has minimum one tower (100) that carries and lifts the whole structure

5. Being a three-propeller counter-rotating wind turbine in accordance with claim 1, its feature is that it is characterized by the blades in the front blade group (106), the rear blade group (104), and the central blade group (105) having preferably an angle of 60 degrees.

6. Being a three-propeller counter-rotating wind turbine in accordance with claim 1, its feature is that it is characterized by the possibility to alter the number and angles of blades in the turbine to adjust turbine performance at an appropriate and desired level according to meteorological data relating to each installation area.

7. Being a three-propeller counter-rotating wind turbine in accordance with claim 1, its feature is that it is characterized by its option to be installed with or without the propeller housing (101).

8. Being a three-propeller counter-rotating wind turbine in accordance with claim 1, its feature is that it is characterized by the fact that in an alternative structuring of the invention, the need for the first rotor (107), the second rotor (108), and the third rotor (109) is eliminated, and the front blade group (106), the central blade group (105) and the rear blade group (104) are directly connected to the body of the counter-rotating generator (103) in order to reduce energy losses at the highest level.
